(19) United States
(12) Patent Application Publication
(10) Pub. No.: US 2007/0096353 A1
(43) Pub. Date: May 3, 2007

(54) Method of producing limestone-simulating concrete

(76) Inventors: Ann P. Gordon, Atmore, AL (US); Donald R. Gordon, Atmore, AL (US)

Correspondence Address: John Wiley Horton, Attorney;Pennington, Moore, Wilkinson, Bell & Dunbar, P.A., P.O. Box 10095, Tallahassee, FL, 32302-2095, US

(21) Appl. No.: 11/265,839

(22) Filed: Nov. 3, 2005

(51) Int. Cl. B28B 1/08

(52) U.S. Cl. 264/69; 264/333; 264/122

(57) ABSTRACT

A new process for creating a decorative surface on a cast concrete tile. A mold is prepared by coating with mold release. An aggregate of water, coloring dye, sand, portland cement, and pea gravel is pre-mixed. Dampened baking soda is sprinkled randomly into the bottom surface of the mold (which will bear against what becomes the top surface of the cast tile). The pre-mixed aggregate is then added to the mold. The aggregate is then screed and compressed in the mold to minimize voids. A plastic cover is next added to reduce the moisture loss rate and increase the curing time. Once the concrete is cured, the mold is separated into its component pieces and the cast concrete tile is removed. The upper surface of the cast tile will have been etched and otherwise transformed by the dampened baking soda, producing a surface texture similar to limestone.

### BACKGROUND OF THE INVENTION

1. Field of the Invention

This invention relates to the field of building materials. More specifically, the invention comprises a method for producing a simulated limestone finish on the surface of cast concrete tiles.

2. Description of the Related Art

Concrete has been used to cast functional and decorative building materials for many years. It may be used, as an example, to pour a monolithic floor slab. A finished surface can be created on such a slab, so that no further flooring material is needed.

Concrete is long-lasting and relatively inexpensive. One drawback, however, is its perceived lack of visual appeal. While some recent innovations in decorative surfaces have improved the appeal of concrete, it does not rival natural stone. Stone pavers or tiles display a natural variation in texture, luster, and color which many people find appealing. Most people prefer the look of natural stone. However, the price of stone—which can be ten times more expensive than concrete—often drives the consumer toward concrete. It would therefore be advantageous to provide a cast concrete product which mimics the desired surface look of natural stone.

### BRIEF SUMMARY OF THE PRESENT INVENTION

The present invention comprises a new process for creating a decorative surface on a cast concrete tile. A mold is prepared by coating with mold release. An aggregate of water, coloring dye, sand, Portland cement, and pea gravel is pre-mixed. Dampened baking soda is sprinkled randomly into the bottom surface of the mold (which will bear against what becomes the top surface of the cast tile). The pre-mixed aggregate is then added to the mold. The aggregate is then screed and compressed in the mold to minimize voids. Aplastic cover is next added to reduce the moisture loss rate and increase the curing time.

Once the concrete is cured, the mold is separated into its component pieces and the cast concrete tile is removed. The upper surface of the cast tile will have been etched and otherwise transformed by the dampened baking soda, producing a surface texture similar to limestone.

### BRIEF DESCRIPTION OF THE SEVERAL VIEWS OF THE DRAWINGS

FIG. 1 is a perspective view, showing a mold used to create a cast tile.

FIG. 2 is a perspective view, showing the mold in an assembled state.

FIG. 3 is a perspective view, showing the addition of the dampened baking soda.

FIG. 4 is a perspective view, showing the filling of the mold.

FIG. 5 is a perspective view, showing the concrete curing in the mold.

FIG. 6 is a detail view, showing the surface finish of a cast tile.

### REFERENCE NUMERALS IN THE DRAWINGS

| | | | |
|---|---|---|---|
| 10 | mold | 12 | base |
| 14 | half frame | 16 | half frame |
| 18 | upper tab | 20 | lower tab |
| 22 | upper tab | 24 | lower tab |
| 26 | hole | 28 | pin |
| 30 | pin hole | 32 | mold cavity |
| 34 | baking soda | 36 | aggregate |
| 38 | shovel | 40 | filled mold |
| 42 | completed tile | 44 | void |
| 46 | color variation | 48 | back side |

### DESCRIPTION OF THE INVENTION

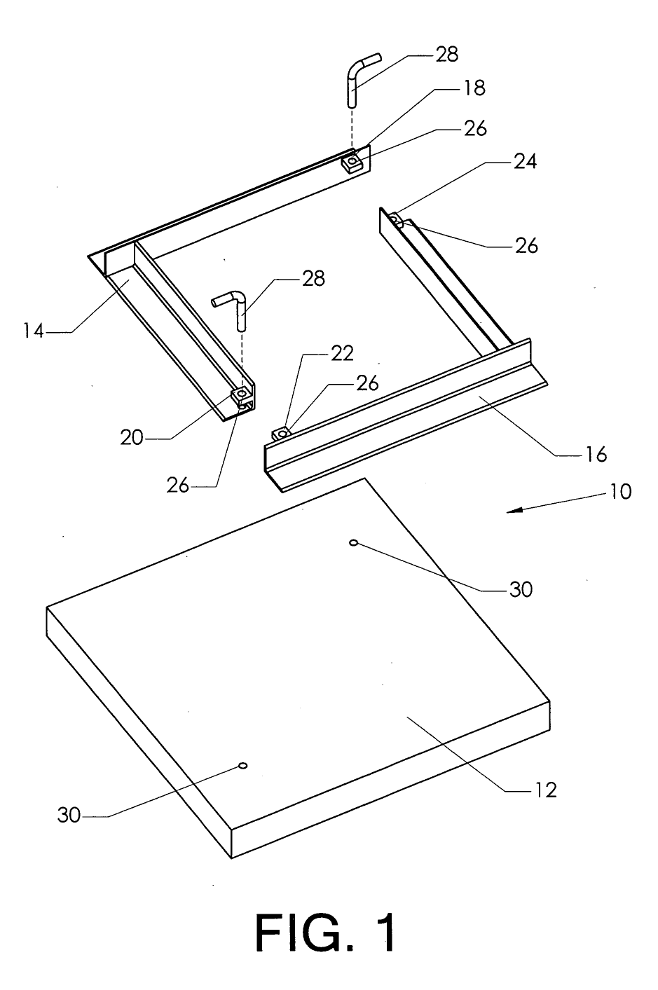

FIG. 1 shows the components of the mold used to create a cast tile. The mold is created by frame 14 and half frame 16 to base 12. Half frame 14 and half frame 16 are both “L” shaped pieces that form a square when joined at their ends. Half frame 14 has upper tab 18 that mates with lower tab 24 of half frame 16 when the two half frames are joined to form a square. Half frame 14 also has lower tab 20 that mates with upper tab 22 of half frame 16 when the square-framed mold is formed. Corresponding holes 26 of upper tab 18 and lower tab 24 and corresponding holes 26 of upper tab 22 and lower tab 20 align when the two frames are joined and the upper and lower tabs are mated.

Base 12 has two pin holes 30 which are adapted to receive pins 28 when the frame is placed on the base. As described above, corresponding holes 26 of upper tab 18 and lower tab 24 and corresponding holes 26 of upper tab 22 and lower tab 20 are aligned when half frame 14 and half frame 16 are joined to form a square. Pins 28 are then inserted through holes 26 and pin holes 30 in base 12.

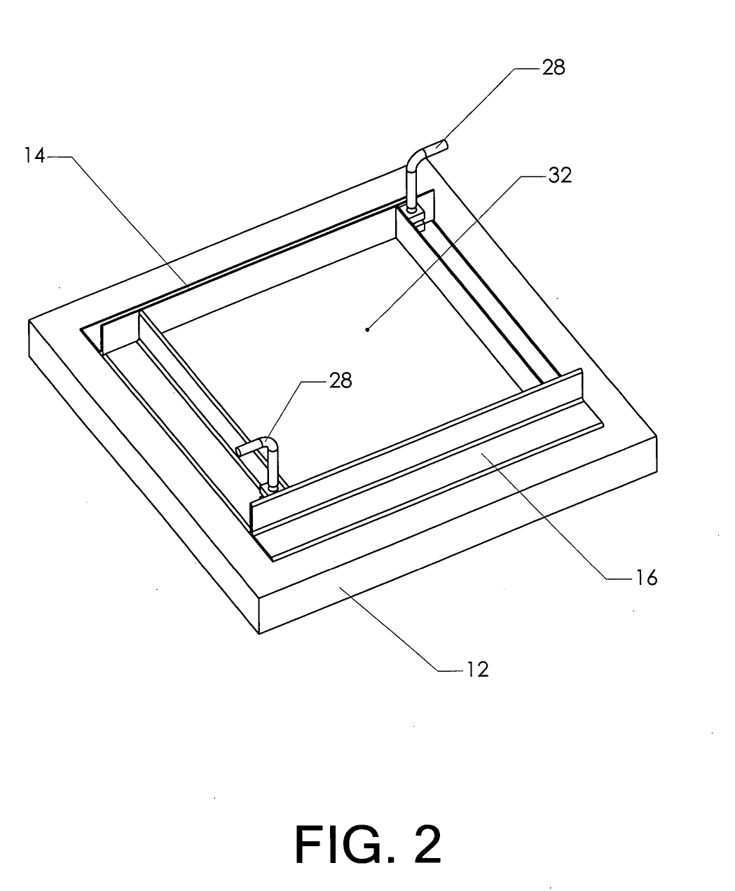

The assembled mold is illustrated in FIG. 2. Half frame 14 and half frame 16 form a square that is connected together and to base 12 by pins 28 as described above. Mold cavity 32 results from the attachment of the two half frames to the base.

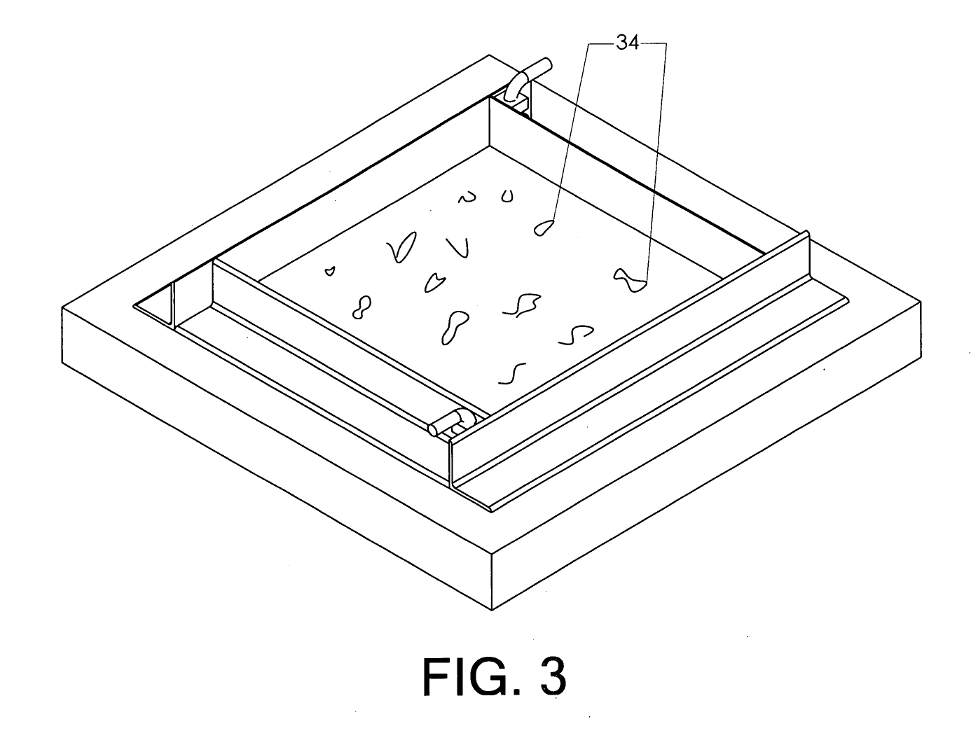

FIG. 3 shows how the mold is prepared to produce concrete tiles with a stone-like appearance. The surfaces of the mold are first prepared with mold release to prevent bondage of the concrete to the mold. Those skilled in the art are familiar with this part of the process and the various products that can be used to prevent bondage. Baking soda 34, sodium bicarbonate, is dampened and then randomly sprinkled across the surface of the base. The addition of baking soda 34 gives the resulting product a porous surface texture that mimics natural stone.

Concrete aggregate must then be made to produce the tiles. The aggregate can be any combination of concrete sand, gravel, cement, coloring agent and water. Those skilled in the art know that the precise formula can be varied to produce concrete with different appearances and properties. The aggregate is formed by mixing the aforementioned ingredients in a mixer. Additionally, the use of an ochre coloring agent is especially effective in creating stone-like coloration. A heterogenous coloration of the mixture can be produced by mixing the ingredients for three to five minutes, i.e., the coloring dye is unevenly distributed.

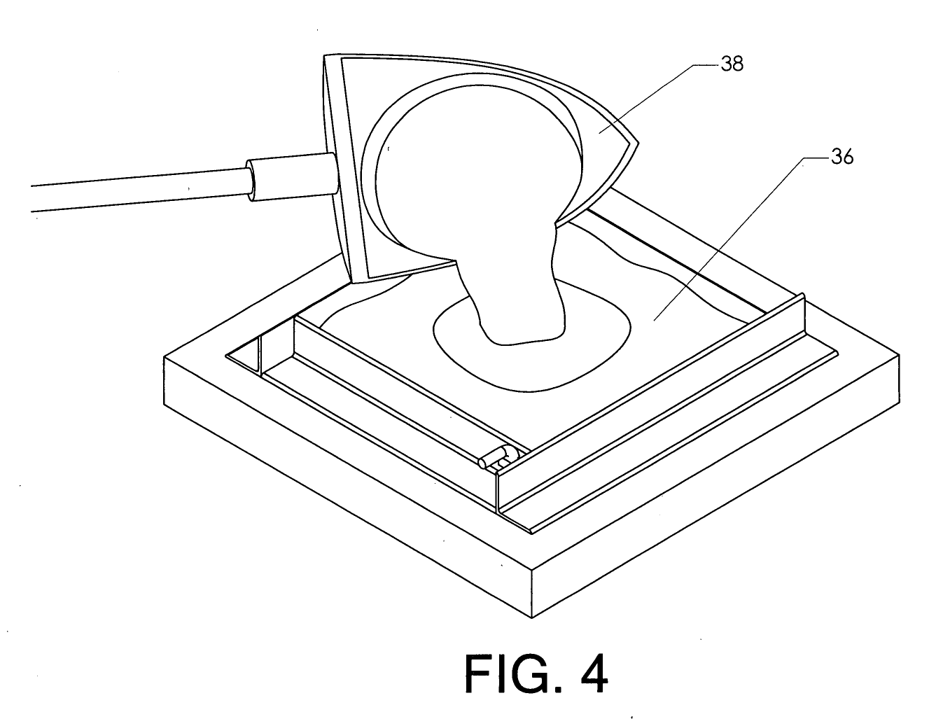

The mold is then filled as shown in FIG. 4. The mold cavity is filled with aggregate 36 using shovel 38. The mold cavity is filled completely with special care given to insure that the corners of the mold are filled and that the aggregate surface is even and level with the mold frame. A screed bar can be raked back and forth across the top of the mold frame to prevent the formation of ridges, lumps, or raised corners.

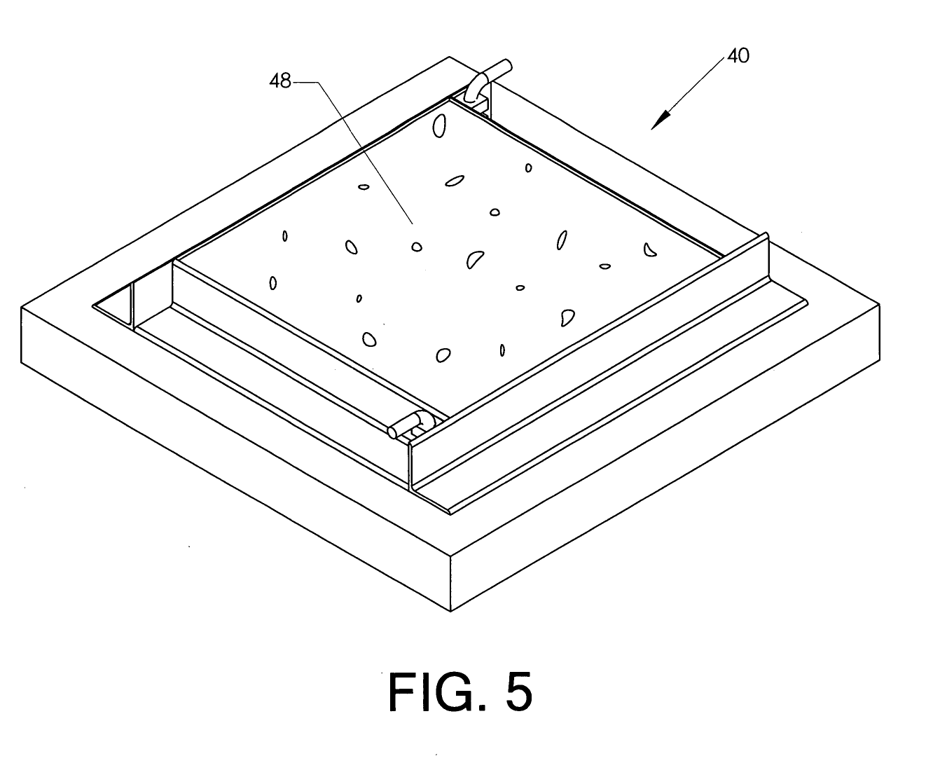

The aggregate is then allowed to cure as shown in FIG. 5. Filled mold 40 is allowed to sit long enough for the aggregate to dry. Those skilled in the art know that the drying time required is dependent upon the aggregate's recipe and environmental conditions like temperature and humidity. The tiles can be covered with plastic wrap during the curing process to help the tiles hold in moisture. Those skilled in the art will know that humidity and temperature control can be added to the curing process to produce a more evenly cured product. Once cured, the tile is released from the mold by removing the pins and tapping the frame with a hammer.

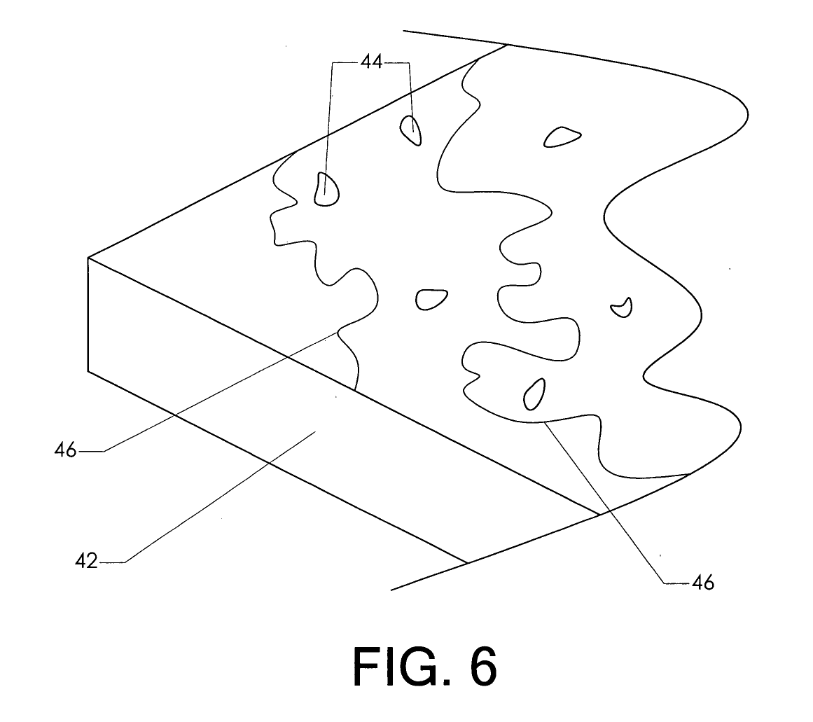

The resulting tile that is produced by this process is shown in FIG. 6. Completed tile 42 serves as an illustration of some of the features and added benefits of this process. First, voids 44 are created where the aggregate cures around the space occupied by the baking soda and gases produced by the reaction of baking soda with the aggregate. This gives the surface of the tile a porous texture that is a similar to the surface of tiles made from natural stone. Additionally, color variation 46 is produced. The line illustrated in FIG. 6 represents the boundary between subtley different hues. This boundary may actually appear blurry or mottled. Color variation is also influenced by the reaction of the baking soda and aggregate. This variation in color is often desirable as it mimics the coloration of natural stone.

Different coloring agents can be used to mimic many variety of natural stone surfaces. 548 Ochre color, an effective coloring agent for producing a natural stone look, is commercially available from the New Riverside Ochre Company located in Cartersville, Ga. Other coloring agents can be used to imitate other naturally occurring stone colorations including dolphin grey, champagne, and rice white. Multiple coloring agents can even be used in the same batch to produce tiles with “swirls” of different colors. Furthermore, the degree of color variation can be controlled by adjusting the mixing time of the aggregate. A longer mixing time will result in a more homogenous coloration, and a shorter mixing time will result in greater color variation across the tile's surface.

The process can be automated as well. One example of an automated process utilizes multi-cavity automated machinery to produce the files with limited human assistance. An automated mixer can be used to prepare the aggregate, and a controller can be used to coordinate mixing and pouring time intervals. Using a conveyer belt or other means of locomotion, mold trays can be fed through various stations. First, the mold trays can be run through a station that sprays mold release. Second, the mold trays can be run through a station that randomly distributes baking soda across a two-dimensional field. The mold trays can then be sent to an injection site to be filled with aggregate. Finally, the trays can be circulated through an autoclave or other drying means to cure the concrete. A controller, like a programmable logic controller, can be used to coordinate the entire process.

Although the preceding descriptions contain significant detail they should not be viewed as limiting the invention but rather as providing examples of the preferred embodiments of the invention. As one example, many types and shapes of molds can be used to produce the concrete tiles. Accordingly, the scope of the invention should be determined by the following claims, rather than the examples given.

Having described our invention, we claim:

1. A method of producing a concrete casting having a stone-mimicking surface, comprising:
a. providing a mold having a base, encircling side walls, and an open top;
b. providing an aggregate, including,
i. sand,
ii. pea gravel,
iii. Portland cement,
iv. coloring dye, and
v. water;
c. randomly distributing dampened baking soda on said base of said mold;
d. filling said mold with said aggregate;
e. allowing said aggregate to harden into a solid, thereby forming said casting; and
f. removing said casting from said mold.

2. A method as recited in claim 1, further comprising coating said mold with mold release prior to filling said mold with said aggregate.

3. A method as recited in claim 1, wherein said coloring dye within said aggregate is an ochre color.

4. A method as recited in claim 1, wherein after said casting is removed from said mold, said surface of said casting which was formed by said mold base is coated with a sealer.

5. A method as recited in claim 1, further comprising agitating said aggregate once said aggregate is placed in said mold in order to reduce voids within said aggregate.

6. A method as recited in claim 1, further comprising screeing the upper surface of said aggregate after said aggregate is placed in said mold.

7. A method as recited in claim 5, further comprising screeing the upper surface of said aggregate after performing said step of agitating said aggregate.

8. A method as recited in claim 1, wherein said step of filling said mold with said aggregate is performed by shoveling said aggregate into said mold with a shovel, thereby trapping air pockets against said mold base.

9. A method as recited in claim 8, further comprising agitating said aggregate once said aggregate is placed in said mold in order to reduce voids within said aggregate.

10. A method as recited in claim 9, further comprising screeing the upper surface of said aggregate after said step of agitating said aggregate.

11. A method as recited in claim 8, wherein said step of randomly distributing dampened baking soda on said base of said mold is carried out by manually sprinkling said dampened baking soda onto said base of said mold.

12. A method of producing a concrete casting having a stone-mimicking surface, comprising:
a. providing a mold having a base, encircling side walls, and an open top;
b. providing an aggregate, including,
i. sand,
ii. pea gravel,
iii. Portland cement,
iv. coloring dye, and
v. water;
c. randomly distributing baking soda on said base of said mold;
d. filling said mold with said aggregate;
e. allowing said aggregate to harden into a solid, thereby forming said casting; and
f. removing said casting from said mold.

13. A method as recited in claim 12, further comprising coating said mold with mold release prior to filling said mold with said aggregate.

14. A method as recited in claim 12, wherein said coloring dye within said aggregate is an ochre color.

15. A method as recited in claim 12, wherein after said casting is removed from said mold, said surface of said casting which was formed by said mold base is coated with a sealer.

16. A method as recited in claim 12, further comprising agitating said aggregate once said aggregate is placed in said mold in order to reduce voids within said aggregate.

17. A method as recited in claim 12, further comprising screeing the upper surface of said aggregate after said aggregate is placed in said mold.

18. A method as recited in claim 14, further comprising screeing the upper surface of said aggregate after performing said step of agitating said aggregate.

19. The concrete casting produced by the method recited in claim 1.

20. The concrete casting produced by the method recited in claim 12.
